(19) United States
(12) Patent Application Publication
(10) Pub. No.: US 2026/0358976 A1
(43) Pub. Date: Nov. 12, 2026

(54) Device, Circuit, and Method for Memory Access According to Data Access Patterns

(71) Applicant: TEXAS INSTRUMENTS INCORPORATED, Dallas, TX (US)

(72) Inventors: Burton Adrik Copeland, Addison, TX (US); Timothy David Anderson, University Park, TX (US)

(21) Appl. No.: 19/664,393

(22) Filed: Apr. 30, 2026

Related U.S. Application Data
(60) Provisional application No. 63/800,617, filed on May 6, 2025.

(51) Int. Cl. G06F 3/06

(52) U.S. Cl. CPC G06F 3/0655; G06F 3/0604; G06F 3/0673

(57) ABSTRACT

A system includes a processor core, a memory access circuit, and a memory. The processor core may issue data read requests to the memory access circuit, which may service the data read requests from the memory. The memory access circuit may include a decoder circuit having a queue, where the queue may store indications of memory access patterns. The decoder circuit may perform read operations from the memory in an order defined by the queue.

### CROSS-REFERENCE TO RELATED APPLICATIONS

The present application claims the benefit of United States Provisional Patent Application 63/800,617, filed May 6, 2025, the disclosure of which is hereby incorporated by reference in its entirety.

### TECHNICAL FIELD

The present application relates to circuits, generally, and more specifically to devices, circuits, and methods for memory access according to data access patterns.

### BACKGROUND

Digital signal processors (DSPs) may be optimized for processing streams of data that may be derived from various input signals, such as sensor data, a video stream, a voice channel, radar signals, biomedical signals, etc. Digital signal processors operating on real-time data may receive an input data stream, perform a filter function on the data stream (such as encoding or decoding) and output a transformed data stream. The system is called real-time because the application fails if the transformed data stream is not available for output when scheduled. Some video encoding may employ a predictable but non-sequential input data pattern. Some applications may employ memory access to load data registers in a data register file and then supply data from the data registers to functional units which perform the data processing.

### SUMMARY

According to an embodiment, a device includes: a processor core; memory; a memory access circuit coupled to the memory and the processor core, wherein the memory access circuit is configured to: receive, from the processor core, a first operand corresponding to a first data access pattern and a second operand corresponding to a second data access pattern; arrange the first operand and the second operand in an order in a queue; fetch, based on the order, first data from the memory based on the first data access pattern; and fetch, based on the order, second data from the memory based on the second data access pattern.

According to an embodiment, a method includes: receiving an indication of a first data access pattern from a processor core; receiving an indication of a second data access pattern from the processor core; storing the indication of the first data access pattern and the indication of the second data access pattern in a memory in an order; and performing data access operations based on the first data access pattern and the second data access pattern in the order.

According to an embodiment, a circuit includes: a decoder circuit including an input configured to receive indications of a plurality of data access patterns from a processor core, wherein the decoder circuit further includes a queue configured to store the indications in an order, further wherein the decoder circuit is configured to generate a plurality of signals corresponding to the plurality of data access patterns in the order; and an address generator circuit configured to receive a set of signals of the plurality of signals from the decoder circuit and, based on the set of signals, to generate a plurality of read requests corresponding to the plurality of data access patterns in the order.

### BRIEF DESCRIPTION OF THE DRAWINGS

For a more complete understanding of the present disclosure, and the advantages thereof, reference is now made to the following descriptions taken in conjunction with the accompanying drawings, in which:

FIG. 1 is an illustration of an example system, according to some embodiments;

FIG. 2 is an illustration of an example system, according to some embodiments;

FIG. 3 is an illustration of example memory access circuit, processor core, and memory, according to some embodiments;

FIG. 4 is an illustration of an example implementation of a decoder circuit, according to some embodiments;

FIG. 5 is a timing diagram, according to some embodiments; and

FIG. 6 is an illustration of an example method, according to some embodiments.

Corresponding numerals and symbols in different figures generally refer to corresponding parts unless otherwise indicated. The figures are drawn to clearly illustrate the relevant aspects of the preferred embodiments and are not necessarily drawn to scale.

### DETAILED DESCRIPTION

The present disclosure is described with reference to the attached figures. The figures are provided merely to illustrate the disclosure. Several aspects of the disclosure are described below with reference to example applications for illustration. It should be understood that numerous specific details, relationships, and methods are set forth to provide an understanding of the disclosure. The present disclosure is not limited by the illustrated ordering of acts or events, as some acts may occur in different orders and/or concurrently with other acts or events. Furthermore, not all illustrated acts or events are required to implement a methodology in accordance with the present disclosure.

The description below illustrates various specific details to provide an in-depth understanding of several example embodiments according to the description. The embodiments may be obtained without one or more of the specific details, or with other methods, components, materials and the like. In other cases, known structures, materials or operations are not shown or described in detail so as not to obscure the different aspects of the embodiments. References to “an embodiment” in this description indicate that a particular configuration, structure or feature described in relation to the embodiment is included in at least one embodiment. Consequently, phrases such as “in one embodiment” that may appear at different points of the present description do not necessarily refer exactly to the same embodiment. Furthermore, specific formations, structures or features may be combined in any appropriate manner in one or more embodiments.

Example embodiments of the present disclosure are summarized here. Other embodiments can also be understood from the entirety of the specification and the claims filed herein.

Various embodiments include memory access circuits, which may fetch data according to data access patterns. For instance, a system may include a processor core, a memory, and a memory access circuit. The memory access circuit may be coupled to both the processor core and to the memory. The memory access circuit may act as an interface to the memory for processor core accesses (e.g., read operations and write operations).

In one example, the memory access circuit may receive an instruction from the processor core, where the instruction may include an opcode and an operand. The opcode may be associated with a data stream, such as a data access read operation from the memory. Furthermore, the operand may correspond to a first data access pattern. In one example, the first data access pattern may include multiple dimensions, and for each dimension, an identification of the dimension, an increment, and a counter for the number of times to access from that dimension. The memory access circuit may also receive a second operand that corresponds to a second data access pattern, and the memory access circuit may receive the second operand either in the same instruction or in a subsequent instruction from the processor core.

The memory access circuit may include a queue and may store the first operand and the second operand in the queue and in an order (e.g., first-in-first-out, first-in-last-out). The memory access circuit may then fetch first data from the memory based on the order and according to the first data access pattern. The memory access circuit may, subsequently, fetch second data from the memory based on the order and according to the second access pattern.

In some examples, the memory access circuit may queue multiple access patterns to be serviced at a time without being reprogrammed. For instance, rather than deleting the first operand in response to receiving the second operand, the memory access circuit may perform the data access operations according to the access patterns, one after the other, based on the order in the queue of the operands. Once an access pattern, corresponding to an operand, has been satisfied (e.g., data retrieved, formatted, and returned to the processor core) the queue may purge the operand. Subsequent additional operands may also be stored into the queue as appropriate.

Various embodiments may include advantages over other systems. For instance, some functions, to be performed by the processor core, may employ multiple access patterns. In one example, a fast Fourier transform (FFT) may include one or more butterfly functions, where each butterfly function may employ multiple access patterns. Some systems may treat each access pattern as speculative, including reprogramming a memory access circuit for each subsequently-received access pattern. However, reprogramming a memory access circuit may entail overhead, and that overhead may be a significant percentage (e.g., in clock cycles) of the processing time of a given access pattern. By contrast, various embodiments described herein may allow for the multiple access patterns to be queued and processed according to an order of the queue. The memory access circuit may process access patterns according to the order in the queue without reprogramming, thereby saving some amount of overhead. Thus, various embodiments may perform operations more efficiently.

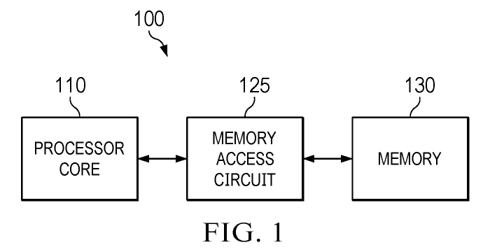

FIG. 1 is an illustration of system 100, according to some embodiments. System 100 includes processor core 110, memory access circuit 125, and memory 130. Processor core 110 may be in communication with memory access circuit 125 through conductive lines, such as traces in an integrated circuit (IC). Similarly, the memory access circuit 125 may be in communication with memory 130 through similar conductive lines. System 100 may be implemented on one or more ICs, such as semiconductor dies, as appropriate.

Processor core 110 may include any appropriate processor core, such as a digital signal processor (DSP), a central processing unit (CPU), a microcontroller, a reduced instruction set computer (RISC), and/or the like. Memory 130 may be implemented as any appropriate type of memory, such as random-access memory (RAM), static RAM (SRAM), cache memory, and/or the like. Although not shown explicitly, memory 130 may include a memory controller circuit, which is configured to read from and write to an array of memory cells within memory 130. Memory access circuit 125 may be implemented using hardware logic, software logic, or a combination of hardware logic and software logic. In one example, processor core 110 may perform read operations and write operations to memory 130 via memory access circuit 125. For instance, processor core 110 may read data from memory 130 by issuing a command to the memory access circuit 125 to read data from memory 130, format that data, and return the data to processor core 110.

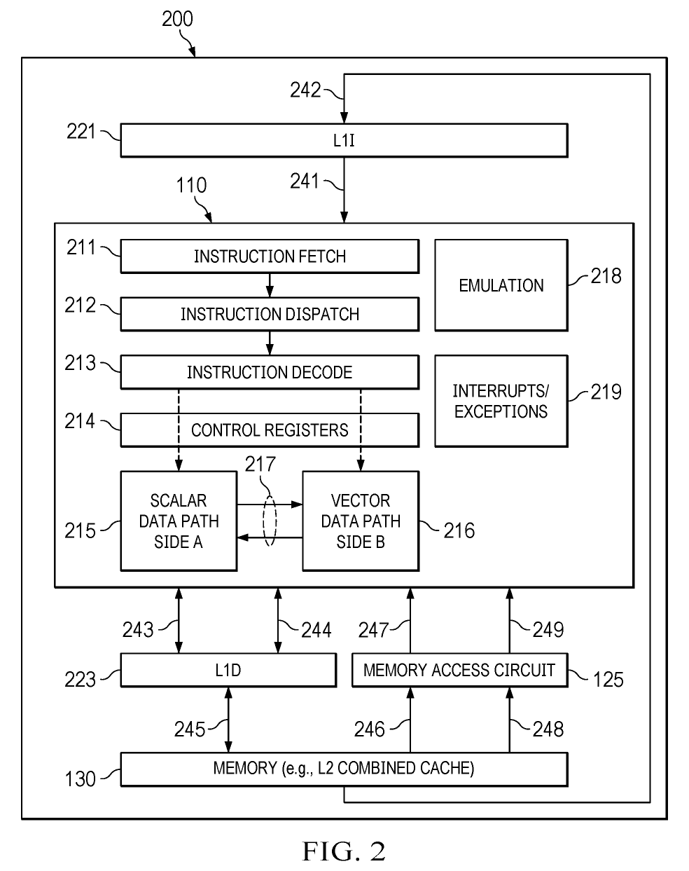

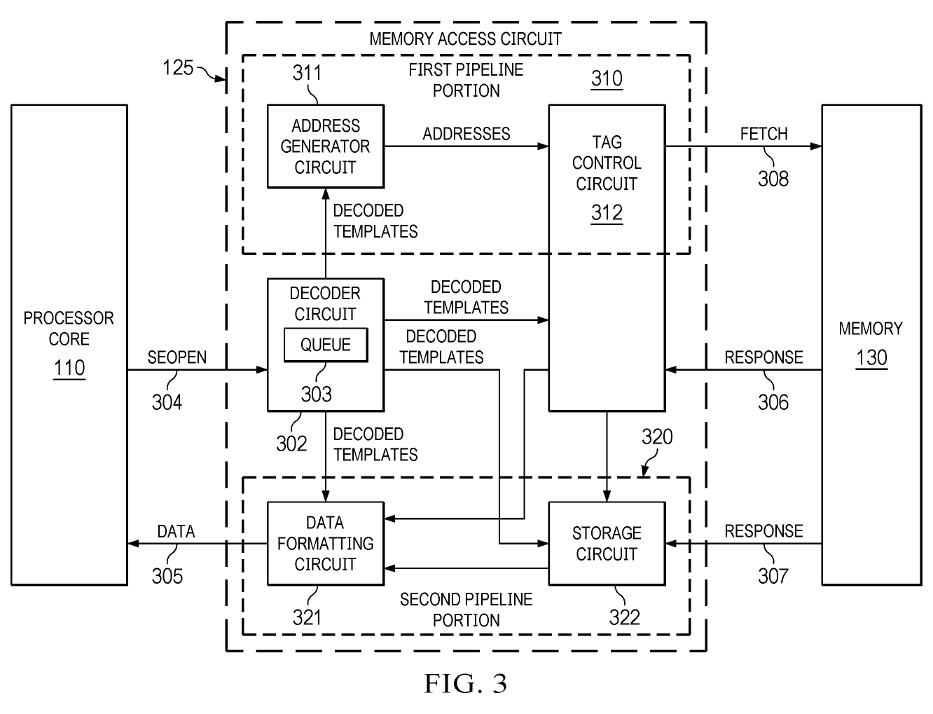

As explained in more detail below with respect to FIG. 3, memory access circuit 125 may include a queue for storing indications of data access patterns. System 100 may be implemented in a larger system, such as discussed with respect to FIG. 2.

FIG. 2 is an illustration of an example system 200, according to some embodiments. System 200 includes processor core 110, memory access circuit 125, and memory 130. System 200 includes dual scalar/ vector data paths 215, 217, where a vector may include a one-dimensional array of data elements that can be accessed and operated on as a unit. System 200 includes separate level one instruction cache (L1I) 221 and level one data cache (L1D) 223. System 200 includes memory 130, which in this example implemented as level 2 (L2) combined instruction/data cache that may hold both instructions and data. FIG. 2 illustrates a connection between L1I cache and memory 130 as bus 242. FIG. 2 illustrates the connection between L1D cache 223 and memory 130 as bus 245.

In the example system 200, memory 130 may store both instructions to back up L1I cache 221 and data to back up L1D cache 223. In this example, memory 130 may be further coupled to higher-level cache (not shown) and/or main memory (not shown) using appropriate memory system techniques not illustrated in FIG. 2. As used herein, the term “higher-level” memory or cache refers to a next level in a memory hierarchy that is more distant from the processor core 110, while the term “lower-level” memory or cache refers to a level in the memory hierarchy that is closer to the processor core 110. L1I cache 221, L1D cache 223, and memory 130 may be implemented in different sizes in various examples. In this example, L1I cache 221 and L1D cache 223 are each 32K bytes, and memory 130 is 1024K bytes, though the scope of implementations is not limited to any memory size. In the example system 200, L1I cache 221, L1D cache 223 and memory 130 may be formed on one or more ICs.

Processor core 110 may fetch instructions from L1I cache 221 as controlled by instruction fetch unit 211. Instruction fetch unit 211 may determine the next instructions to be executed and may recall a fetch packet sized set of such instructions. Instructions may be directly fetched from L1I cache 221 upon a cache hit if the instructions are stored in L1I cache 221. Upon a cache miss occurring when the specified instructions are not stored in L1I cache 221, the instructions may be sought in memory 130. In this example, the size of a cache line in L1I cache 221 equals the size of a fetch packet, such as 512 bits. The memory locations of these instructions are either a hit in memory 130 or a miss. A hit may be serviced from memory 130. A miss may be serviced from a higher level of cache (not illustrated) or from main memory (not illustrated). In this example, the requested instruction is simultaneously supplied to both L1I cache 221 and processor core 110 to speed use.

In this example, processor core 110 includes multiple functional units to perform instruction-specified data processing tasks. Instruction dispatch unit 212 may determine the target functional unit of each fetched instruction. In this example, processor core 110 may operate as a very long instruction word (VLIW) processor capable of operating on multiple instructions in corresponding functional units simultaneously. A compiler (not shown) may organize instructions in execute packets that are executed together. Instruction dispatch unit 212 may direct each instruction to its target functional unit. The functional unit assigned to an instruction may be specified by the instruction produced by the compiler. In this example, instruction dispatch unit 212 may operate on several instructions in parallel. The number of such parallel instructions may be set by the size of the execute packet.

One part of the dispatch task of instruction dispatch unit 212 may include determining whether the instruction is to execute on a functional unit in scalar data path side A 215 or vector data path side B 216. An instruction bit within each instruction called the s bit may determine which data path the instruction controls.

Instruction decode unit 213 may decode each instruction in a current execute packet. Decoding may include identification of the functional unit performing the instruction, identification of registers used to supply data for the corresponding data processing operation from among possible register files, and identification of the register destination of the results of the corresponding data processing operation. The result of this decoding may include signals for control of the target functional unit to perform the data processing operation specified by the corresponding instruction on the specified data.

Processor core 110 includes control registers 214. Control registers 214 may store information for control of the functional units in scalar data path side A 215 and vector data path side B 216. This information may include mode information or the like.

The decoded instructions from instruction decode 213 and information stored in control registers 214 may be supplied to scalar data path side A 215 and vector data path side B 216. As a result, functional units within scalar data path side A 215 and vector data path side B 216 may perform instruction specified data processing operations upon instruction specified data and store the results in an instruction specified data register or registers. Each of scalar data path side A 215 and vector data path side B 216 may include multiple functional units that operate in parallel. There is a data path 217 between scalar data path side A 215 and vector data path side B 216 permitting data exchange.

Processor core 110 may include further non-instruction-based modules. Emulation unit 218 may permit determination of the machine state of processor core 110 in response to instructions. This capability may be employed for algorithmic development. Interrupts/exceptions unit 219 may enable processor core 110 to be responsive to external, asynchronous events (interrupts) and to respond to attempts to perform improper operations (exceptions).

Memory access circuit 125 may supply two data streams from predetermined addresses cached in memory 130 to register files of vector data path side B of processor core 110. This provides controlled data movement from memory (as cached in memory 130) directly to functional unit operand inputs.

FIG. 2 illustrates example data widths of busses between various parts. L1I cache 221 may supply instructions to instruction fetch unit 211 via bus 241. Bus 241 may be sized as appropriate, such as 512-bits. Bus 241 is unidirectional from L1I cache 221 to processor core 110. Memory 130 may supply instructions to L1I cache 221 via bus 242. Bus 242 may be sized as appropriate, such as 512-bits. Bus 242 is unidirectional from memory 130 to L1I cache 221.

L1D cache 223 may exchange data with register files in scalar data path side A 215 via bus 243. Bus 243 may be sized as appropriate, such as 64-bits. L1D cache 223 may exchange data with register files in vector data path side B 216 via bus 244. Bus 244 may be sized as appropriate, such as 512-bits. Busses 243 and 244 are illustrated as bidirectional supporting both processor core 110 data reads and data writes. L1D cache 223 exchanges data with memory 130 via bus 245. Bus 245 may be sized as appropriate, such as 512-bits. Bus 245 is illustrated as bidirectional supporting cache service for both processor core 110 data reads and data writes.

Processor data requests may be directly fetched from L1D cache 223 upon a cache hit (if the requested data is stored in L1D cache 223). Upon a cache miss (the specified data is not stored in L1D cache 223), the data may be sought in memory 130. The memory locations of the requested data are either a hit in memory 130 or a miss. A hit may be serviced from memory 130, via memory access circuit 125. A miss may be serviced from another level of cache (not illustrated) or from main memory (not illustrated). The requested data may be simultaneously supplied to both L1D cache 223 and processor core 110 to speed use.

Memory 130 may supply data of a first data stream to memory access circuit 125 via bus 246. Bus 246 may be sized as appropriate, such as 512-bits. Memory access circuit 125 may supply data of the first data stream to functional units of vector data path side B 216 via bus 247. Bus 247 may be sized as appropriate, such as 512-bits. Memory 130 may supply data of a second data stream to memory access circuit 125 via bus 248. Bus 248 may be sized as appropriate, such as 512-bits. Memory access circuit 125 may supply data of this second data stream to functional units of vector data path side B 216 via bus 249, which may be sized as appropriate, such as 512-bits. Busses 246, 247, 248 and 249 are illustrated as unidirectional from memory 130 to memory access circuit 125 and to vector data path side B 216 in accordance with this example.

Memory access circuit data requests are directly fetched from memory 130 upon a cache hit (if the requested data is stored in memory 130). Upon a cache miss (the specified data is not stored in memory 130), the data may be sought from another level of cache (not illustrated) or from main memory (not illustrated). It may be feasible in some examples for L1D cache 223 to cache data not stored in memory 130. If such operation is supported, then upon a memory access circuit data request that is a miss in memory 130, memory 130 may snoop L1D cache 223 for the memory access circuit requested data. If L1D cache 223 stores the data, the snoop response includes the data, which may then be supplied to service the memory access circuit request. If L1D cache 223 does not store the data, the snoop response may indicate this and memory 130 services the memory access circuit request from another level of cache (not illustrated) or from main memory (not illustrated).

Of course, memory sizes and bus sizes may be scaled as appropriate. System 200 may be implemented in any appropriate manner. In one example, system 200 may be fabricated on an integrated chip (IC) that is mounted on a ball grid array (BGA) substrate. Further in this example, any appropriate packaging techniques may be used with system 200.

FIG. 3 is an illustration of memory access circuit 125, processor core 110, and memory 130, according to some embodiments. FIG. 3 is provided to show an example hardware logic implementation of memory access circuit 125. For instance, data formatting circuit 321, and tag control circuit 312, and address generator circuit 311 may be implemented as arrays of logic gates configured to perform the functionality described herein.

Memory address circuit 125 includes a first pipeline portion 310 and a second pipeline portion 320. The first pipeline portion 310 includes address generator circuit 311 and tag control circuit 312. The second pipeline portion 320 includes data formatting circuit 321 and storage control circuit 322. The first pipeline portion 310 is configured to read data from memory 130, and the second pipeline portion 320 is configured to format and transmit data, which has been read from memory 130, to processor core 110.

In this example, the decoder circuit 302 is implemented in memory access circuit 125. The decoder circuit 302 includes queue 303. Processor core 110 is coupled to the decoder circuit 302 by conductive line 304. The processor core 110 may issue an instruction (e.g., a command), which may be structured as an opcode and one or more operands, via conductive line 304. For instance, an opcode may indicate a command Streaming Engine Open (SEOPEN), and the operand (or operands) may include one or more templates. In this example, templates include descriptions of data access patterns, and the command SEOPEN instructs memory access circuit 125 to perform a read operation. The decoder circuit 302 may decode the command by generating hardware signals, shown as decoded templates in FIG. 3. For instance, the hardware signals may be transmitted to the address generator circuit 311, the tag control circuit 312, the storage control circuit 322, and the data formatting circuit 321. The hardware signals may be configured to implement data retrieval and/or formatting according to one or more data access patterns.

In one example use case, the processor core 110 may transmit a command, which includes multiple operands as templates, where each of the templates corresponds to a respective data access pattern. The decoder circuit 302 may receive the command and store the opcodes (e.g., the templates) in the queue 303 in an order, such as first-in-first-out, first-in-last-out, and/or the like. In the present example, the queue 303 may store the templates in a first-in-first-out order. Further in this example, there may be two templates for ease of illustration, but the scope of implementations is not limited to any quantity of templates.

The decoder circuit 302 may select a first template from queue 303, decode that template into hardware signals, and transmit those hardware signals as decoded templates to the address generator circuit 311. The address generator circuit 311 may generate further hardware signals, corresponding to addresses within memory 130, and transmit those further hardware signals to tag control circuit 312. In this example, memory access circuit 125 includes its own cache, implemented as storage control circuit 322. For instance, as data is fetched from memory 130, the data may be stored in storage control circuit 322, and the addresses of the cached data may be stored in tag control circuit 312. Further commands directed to the same data may be then read from the storage control circuit 322, rather than from memory 130. In this example, storage circuit 322 may be implemented as any appropriate memory, such as cache memory, and tag control circuit may be implemented using hardware logic configured with cache control functionality.

Continuing with the example, the address generator circuit 311 may generate the further hardware signals, which are received by the tag control circuit 312. Assuming that the requested data is not already cached in storage control circuit 322, then the further hardware signals may be used to fetch the requested data from memory 130. The first pipeline portion 310 is coupled to the memory 130 by conductive line 308, on which the further hardware signals are transmitted. In response, the memory 130 may read the requested data and transmit a response on conductive lines 306, 307. In this example, the requested data is received and cached by storage control circuit 322 over conductive line 307, and tag control circuit 312 may store the address of the newly-cached data. In this example, the conductive lines 306, 307 may correspond to the buses 246, 248 of FIG. 2. The storage control circuit 322 may then transmit the fetched data to the data formatting circuit 321.

The data formatting circuit 321 may also receive the decoded templates, including a decoded template corresponding to the first template (e.g., corresponding to the first access pattern). The data formatting circuit 321 may be configured to format the data as appropriate. For instance, formatting the data may include adjusting a byte size (e.g., width), adding padding, and/or the like. The decoded template may cause the data formatting circuit 321 to format the data as appropriate. Thus, in this example, the first decoded template (e.g., corresponding to the first data access pattern), may be used by both the address generator circuit 311 and the data formatting circuit 321. The data formatting circuit 321 may then transmit the data to the processor core over conductive line 305. For instance, conductive line 305 may correspond to either one or both of buses 247, 249 of FIG. 2.

As noted above, queue 303 may store further templates, such as the second template in this example. Overlapping in time with the data formatting circuit 321 operating according to the first decoded template, the decoder circuit 302 may transmit a decoded template corresponding to the second template (e.g., corresponding to a second data access pattern) to the address generator circuit 311. Thus, the address generator circuit 311 may generate addresses based on the second decoded template overlapping in time with the data formatting circuit 321 formatting data according to the first decoded template.

Continuing with the example, the address generator circuit 311 may then generate further hardware signals, corresponding to addresses of the requested data, and transmit those further hardware signals to the tag control circuit 312. For purposes of this example, it is assumed that the requested data has been cached and is stored in the storage control circuit 322. Accordingly, the tag control circuit 312 may determine a cache hit, based on the address, and transmit a message to the storage control circuit 322 indicating the cache hit. The decoder circuit 302 may transmit the decoded second template to the storage control circuit 322, which may internally fetch the requested data based on the decoded second template. The storage control circuit 322 may then return the requested data, transmitting the requested data to the data formatting circuit 321. The data formatting circuit 321 may then perform formatting operations based on the decoded second template to generate formatted data and transmit the formatted data to the processor core via conductive line 305. Tag control circuit 312 is illustrated as partly within and partly outside first pipeline portion 310 because tag control circuit 312 may perform some read functions (associated with first pipeline portion 310) and to cause data to be transmitted to data formatting circuit 321 (associated with second pipeline portion 320).

Of course, the scope of embodiments may include further templates stored in queue 303. In an example in which a further, third template is stored in the queue 303, then the decoder circuit 302 may transmit hardware signals based on the third decoded template to the address generator circuit 311 overlapping in time with the data formatting circuit 321 formatting requested data according to the decoded second template.

In various examples, a command (e.g., SEOPEN) may include as many operands indicating as many data access patterns as appropriate. For instance, a command may include only a single operand indicating only a single data access pattern, may include a single operand indicating multiple data access patterns, or may include multiple operands indicating multiple data access patterns. The decoder circuit 302 may then store the operands (e.g., templates) in the appropriate order within the queue 303. Also, in this example, the decoder circuit 302 may receive further commands and may store further operands from those further commands in the queue 303 as appropriate.

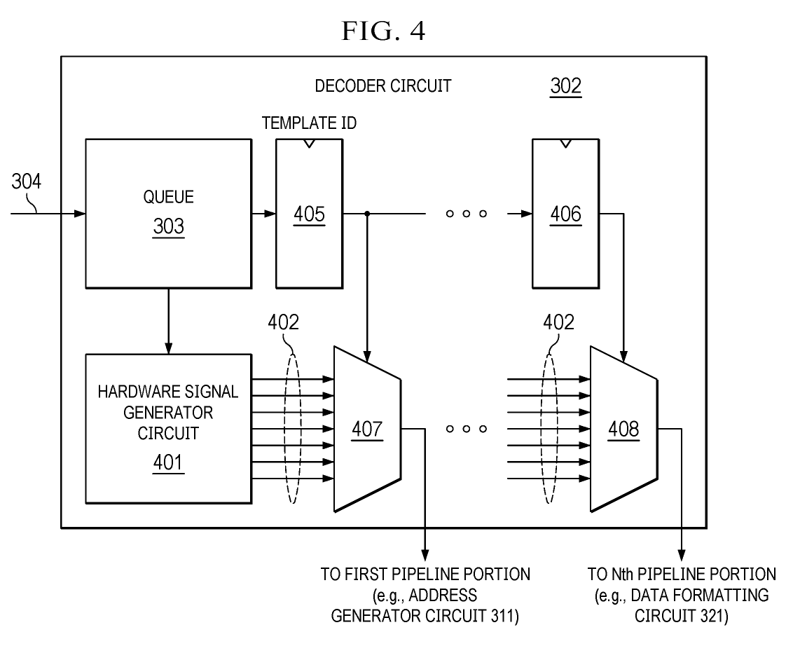

As described above, in this example, the second pipeline portion 320 may receive a decoded template overlapping in time with the first pipeline portion 310 receiving a newer decoded template. FIG. 4 is an illustration of an example implementation of decoder circuit 302, according to some embodiments, to provide such functionality.

Decoder circuit 302 includes queue 303, which is configured to receive a command (e.g., SEOPEN) over conductive line 304. Queue 303 may store the operands (e.g., templates) in an order, such as discussed above. Queue 303 is coupled to register 405 and to register 406. In this example, only two registers 405, 406 are illustrated for convenience, but it is understood that decoder circuit 302 may include N registers and N multiplexers, as indicated by the ellipses. For instance, register 405 may be coupled to a subsequent register (not shown), and that subsequent register may be coupled to register 406. In one example, the queue 303 may be configured to output a template identifier (ID) with each clock cycle, and each register 405, 406 may be configured to store and then output a template ID at each clock cycle. Thus, as clock cycles continue to arrive, a given template ID may be shifted from one register to the next and on and on with each clock cycle.

In this example, the output terminal of each register 405, 406 is coupled to a respective control terminal of a multiplexer 407, 408. For instance, the output terminal of register 405 is coupled to the control terminal of multiplexer 407, and the output terminal of register 406 is coupled to the control terminal of multiplexer 408.

Hardware signal generator circuit 401 is coupled to queue 303, and hardware signal generator circuit 401 is configured to decode the operands (e.g., templates) from the queue 303 by generating hardware signals 402 based on the operands. In other words, the hardware signals 402 represent decoded templates. In the present example, hardware signal generator circuit 401 may be configured to decode multiple operands at a time. For instance, hardware signal generator circuit 401 may be configured to decode each of the operands stored in queue 303 at a given time and to output hardware signals 402, with each individual hardware signal corresponding to a respective decoded template. In this example, hardware signal generator circuit 401 is implemented in decoder circuit 302.

Further in the present example, queue 303 may be configured to output template IDs according to the order of the templates in queue 303. In a first-in-first-out order, the queue 303 may output a first-received template ID first, a second-received template ID second, and on and on. In such an example, the first-received template ID may shift through registers 405, 406, followed by the second-received template ID, and on and on.

In one example having only two registers 405, 406 (for simplicity of illustration), queue 303 may output a first template ID for a first-received template to the register 405, which stores the first template ID. It is assumed in this example that the register 406 may store a null value. At this point, the output terminal of register 405 outputs the first template ID to the control terminal of multiplexer 407, which selects one of the decoded templates (one of 402) to output to a first pipeline portion based on the template ID. For instance, the first pipeline portion may include the address generator circuit 311, and the decoded template may correspond to the first-received operand.

On the next clock cycle, the register 405 may output the first template ID to the register 406, which stores the first template ID, and queue 303 may output a second template ID for a second-received template to the register 405. At this point, the output terminal of the register 405 may input the second template ID to the control terminal of multiplexer 407, which may cause the multiplexer 407 to output one of the decoded templates (one of 402) to the first pipeline portion. Thus, multiplexer 407 may select a decoded template corresponding to the second-received template. Similarly, the output terminal of register 406 may input the first template ID to the control terminal of multiplexer 408, which may cause the multiplexer 408 output another one of the decoded templates to the Nth pipeline portion. Thus, multiplexer 408 may select the decoded template corresponding to the first-received template. Thus, looking to the example of FIG. 3, the data formatting circuit 321 may receive the decoded template corresponding to the first-received template overlapping in time with the address generator circuit 311 receiving the decoded template corresponding to the second-received template.

Of course, the scope of implementations is not limited to a single register and a single multiplexer for each pipeline portion, such as pipeline portions 310, 320 of FIG. 3. Rather, the scope of implementations may include as many registers and multiplexers as may be appropriate to transmit decoded templates to a given component (e.g., address generator circuit 311, tag control circuit 312, storage control circuit 322, data formatting circuit 321) according to a desired timing. Furthermore, the registers 405, 406 and the multiplexers 407, 408 are not necessarily limited to operating at each clock cycle. Rather, the registers 405, 406 and the multiplexers 407, 408 may be operated at any appropriate clock cycle step, such as one cycle, two cycles, or the like.

A potential advantage of some embodiments is that the architecture of decoder circuit 302 may be designed to provide desired decoded templates at desired timing requirements to multiple components, thereby allowing multiple pipeline portions to operate simultaneously, thus increasing efficiency of memory access circuit 125.

Another potential advantage may include that the queue 303 may store multiple templates at the same time and work through the templates in a set order. For instance, the queue 303 may receive operands corresponding to templates, store those operands, cause the operands to be decoded, and cause the decoded operands (e.g., decoded templates) to be provided to various components according to a desired order and according to timing requirements with minimal overhead. For instance, decoder circuit 302 may provide decoded templates, one after the other, without being erased and reset for each template, which would otherwise result in further overhead.

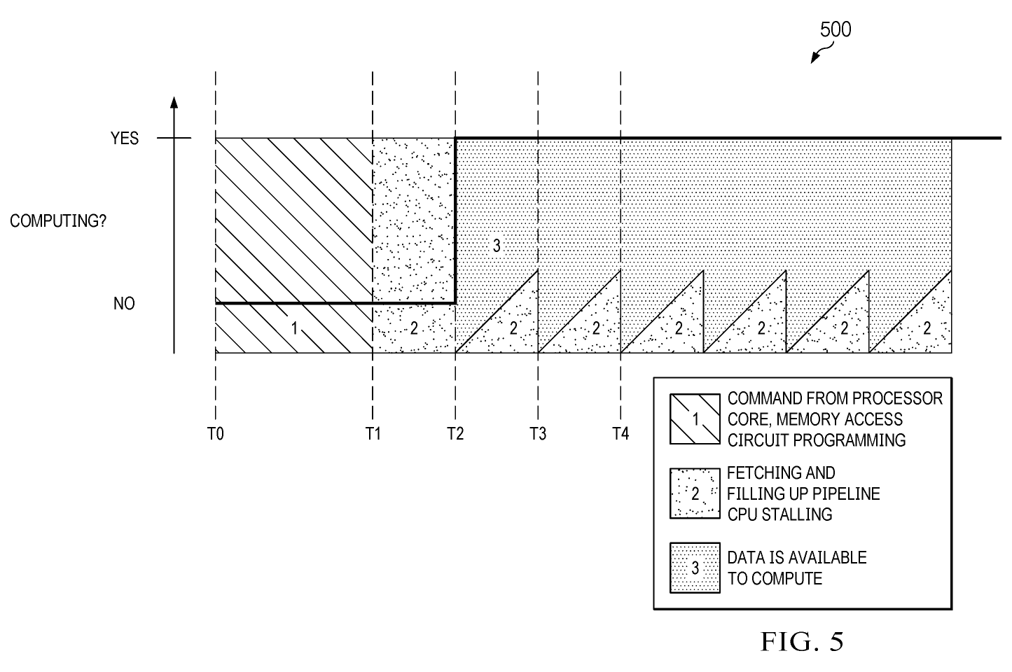

FIG. 5 is a timing diagram 500, according to some embodiments. Timing diagram 500 may represent timing and operation of system 100 of FIG. 1 in some examples.

At time T0, the processor core 110 may generate a command (e.g., SEOPEN), which acts as a read request for data according to a data access pattern. The command may be received by memory access circuit 125, which includes decoder circuit 302. In this example, the data access pattern may be multi-dimensional. In one example, the data access pattern may include multiple dimensions, and for each dimension, an identification of the dimension, an increment, and a counter for the number of times to access from that dimension. Thus, the data access pattern may be relatively complex and may result in reading a relatively large amount of data for a single read operation. In some examples, such a read operation may be referred to as a streaming operation.

Furthermore, in this embodiment, the command may include multiple operands, each of the operands corresponding to a data access pattern. In another example, the processor core 110 may generate multiple commands serially, where each command includes one or more operands corresponding to a data access pattern. In any event, the queue 303 may store multiple operands in an order.

At time T1, the memory access circuit 125 is in the process of fetching the requested data based on the command. However, the memory access circuit 125 has not yet returned the data to the processor core 110 and, thus, the processor core 110 may stall between times T1 and T2. Between times T1 and T2, the memory access circuit 125 fetches data, formats the data, and returns the data to the processor core 110. As described above with respect to FIGS. 3 and 4, the memory access circuit 125 may include at least a first pipeline portion 310 and a second pipeline portion 320, which may operate simultaneously (e.g., overlapping in time) so that the second pipeline portion 320 may format data based on a first operand (e.g., corresponding to a first template) overlapping in time with the first pipeline portion 310 fetching data based on a second operand (e.g., corresponding to a second template).

By time T2, the memory access circuit 125 has transmitted the first requested data based on the first operand to the processor core 110. At time T2, the processor core 110 may exit its stall and perform computations on the first-requested data (e.g., corresponding to the first template). Also, at times T1 and T2, the decoder circuit 302 may continue to provide decoded templates to the first pipeline portion 310 and the second pipeline portion 320.

Between times T2 and T3, the processor core 110 processes the first-requested data while the memory access circuit 125 formats second-requested data (e.g., corresponding to a second template) and fetches third-requested data (e.g., corresponding to a third template). Depending on the amount of time processor core 110 uses to process the first-requested data, there may be some amount of stalling.

Between times T3 and T4, the processor core 110 receives and processes the second-requested data while the memory access circuit 125 formats the third-requested data and fetches fourth-requested data (e.g., corresponding to a fourth template). Although the referenced times end at time T4, it is understood that the fetching and formatting may continue for as long as memory access circuit 125 has operands to service.

A potential advantage of some embodiments is that the memory access circuit 125 may fetch data and format data according to the order of the operands in the queue 303, operating first pipeline portion 310 and second pipeline portion 320 overlapping in time to provide each requested data with minimal delay. Such minimal delay may allow for minimal stalling of processor core 110, thereby allowing for more efficient operation of system 100.

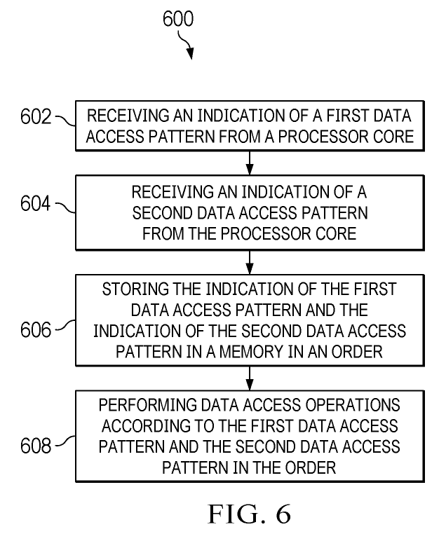

FIG. 6 is an illustration of an example method 600, according to some embodiments. Method 600 may be performed by a memory access circuit, such as memory access circuit 125.

At action 602, the memory access circuit may receive an indication of a first data access pattern from a processor core (e.g., processor core 110). The indication of the first data access pattern may include an operand of a command, such as a read command, from the processor core. However, the scope of implementations is not limited to an operand of a command. Rather, the indication of the first data access pattern may be received in any appropriate manner, such as by a hardware signal incorporating the indication of the data access pattern. Examples of indications of data access patterns include templates, discussed above with respect to FIGS. 3 and 4. In some examples, the first data access pattern may be single-dimensional or multi-dimensional.

At action 604, the memory access circuit may receive an indication of a second data access pattern from the processor core. Action 604 may be similar to action 602, though the second data access pattern may be different from the first data access pattern.

Action 606 includes the memory access circuit storing the indication of the first data access pattern and the indication of the second data access pattern in a memory in an order. An example of the memory in which the indications of the data access patterns are stored may include queue 303. Queue 303 may be implemented in any appropriate manner, such as by RAM, cache memory, and/or the like.

Furthermore, the memory of action 606 may store the indications of the first and second data access patterns in an order, such as first-in-first-out, first-in-last-out, a random order, and/or the like. The memory of action 606 may store the indications of the first and second data access patterns in any appropriate order.

Action 608 includes the memory access circuit performing data access operations according to the first data access pattern and the second data access pattern in the order. For instance, the memory of action 606 (e.g., queue 303) may store the indication of the first data access pattern in a first-received place within the order and may store the indication of the second data access pattern in a second-received place within the order. The memory access circuit may decode the first access pattern and then decode the second access pattern to read from a memory (e.g., memory 103 or storage control circuit 322), format the data, and provide the formatted data to the processor core. In an example in which the data access patterns are multi-dimensional, the memory access circuit may perform a read operation from the memory, dimension by dimension, for the first data access pattern and may perform an additional read operation from the memory, dimension-by-dimension for the second data access pattern.

In one example, the processor core may transmit the indication of the first data access pattern and the indication of the second data access pattern to the memory access circuit in two separate, serial commands. In such an example, the action 608 may include decoding the first command, including generating first memory addresses, and then decoding the second command, including generating second memory addresses. In another example, the processor core may transmit the indication of the first data access pattern and the indication of the second data access pattern to the memory access circuit in a single command. In any event, the memory access circuit may store the indications of the first data access pattern and the second data access pattern in an order, such as discussed above with respect to action 606.

In one example, the memory access circuit may fetch first data according to the first data access pattern, then format the first data while fetching second data according to the second data access pattern, then transmit the first data (formatted) to the processor core while formatting the second data. The memory access circuit may continue to fetch and format further data according to subsequently-received indications of data access patterns as appropriate, such as described above with respect to FIG. 5. As the memory access circuit services the data access patterns, and as subsequent data access patterns are received, the memory access circuit may purge serviced templates, shift those templates being serviced within the queue, and store the subsequently received templates in the queue in the order.

While various examples of the present disclosure have been described above, it should be understood that they have been presented by way of example only and not limitation. Numerous changes to the disclosed examples can be made in accordance with the disclosure herein without departing from the spirit or scope of the disclosure. Modifications are possible in the described embodiments, and other embodiments are possible, within the scope of the claims. Thus, the breadth and scope of the present invention should not be limited by any of the examples described above. Rather, the scope of the disclosure should be defined in accordance with the following claims and their equivalents.

What is claimed is:

1. A device comprising:
a processor core;
memory;
a memory access circuit coupled to the memory and the processor core, wherein the memory access circuit is configured to:
receive, from the processor core, a first operand corresponding to a first data access pattern and a second operand corresponding to a second data access pattern;
arrange the first operand and the second operand in an order in a queue;
fetch, based on the order, first data from the memory based on the first data access pattern; and
fetch, based on the order, second data from the memory based on the second data access pattern.

2. The device of claim 1, wherein the device comprises a digital signal processor (DSP).

3. The device of claim 1, wherein the memory access circuit comprises:
a first pipeline portion configured to read the first data and the second data from the memory; and
a second pipeline portion configured to transmit the first data and the second data to the processor core.

4. The device of claim 3, wherein the first pipeline portion comprises:
an address generator circuit, configured to read the first data from the memory based on the first data access pattern and to read the second data from the memory based on the second data access pattern.

5. The device of claim 4, wherein the second pipeline portion comprises:
a data formatting circuit, configured to format the first data based on the first data access pattern and to format the second data based on the second data access pattern.

6. The device of claim 5, wherein the data formatting circuit is configured to:
format the first data, based on the first data access pattern, overlapping in time with the address generator circuit reading the second data from the memory.

7. The device of claim 1, wherein the first data access pattern and the second data access pattern are multi-dimensional.

8. The device of claim 1, wherein the processor core is configured to:
transmit a command to the memory access circuit, wherein the command includes the first operand and the second operand.

9. The device of claim 1, wherein the processor core is configured to:
transmit a first command to the memory access circuit, wherein the first command includes the first operand; and
transmit a second command to the memory access circuit, wherein the second command includes the second operand.

10. The device of claim 1, wherein the memory access circuit comprises:
a first pipeline portion configured to read the first data and the second data from the memory;
a second pipeline portion configured to transmit the first data and the second data to the processor core; and
a decoder circuit configured to:
transmit first signals representing the first operand and second signals representing the second operand to the first pipeline portion; and
transmit the first signals and the second signals to the second pipeline portion.

11. A method comprising:
receiving an indication of a first data access pattern from a processor core;
receiving an indication of a second data access pattern from the processor core;
storing the indication of the first data access pattern and the indication of the second data access pattern in a memory in an order; and
performing data access operations based on the first data access pattern and the second data access pattern in the order.

12. The method of claim 11, wherein receiving the indications of the first data access pattern and the second data access pattern comprises:
receiving a first command, which includes the indication of the first data access pattern as a first operand; and
receiving a second command, subsequent to the first command, wherein the second command includes the indication of the second data access pattern as a second operand.

13. The method of claim 12, wherein performing the data access operations comprises:
decoding the first command, including generating first addresses associated with an additional memory, wherein the first addresses correspond to the first data access pattern; and
subsequent to decoding the first command, decoding the second command, including generating second addresses associated with the additional memory, wherein the second addresses correspond to the second data access pattern.

14. The method of claim 11, wherein performing the data access operations comprises:
reading first data, from an additional memory, based on the second data access pattern; and
formatting second data, from the additional memory, based on the first data access pattern, wherein formatting the second data is performed overlapping in time with reading the first data.

15. The method of claim 14, wherein reading the first data comprises:
performing a first read operation based on a first dimension of the second data access pattern; and
performing a second read operation based on a second dimension of the second data access pattern.

16. The method of claim 14, wherein formatting the second data comprises:
adjusting a byte size of the second data based on the first data access pattern.

17. A circuit comprising:
a decoder circuit including an input configured to receive indications of a plurality of data access patterns, wherein the decoder circuit further includes a queue configured to store the indications in an order, further wherein the decoder circuit is configured to generate a plurality of signals corresponding to the plurality of data access patterns in the order; and
an address generator circuit configured to receive a set of signals of the plurality of signals from the decoder circuit and, based on the set of signals, to generate a plurality of memory addresses corresponding to the plurality of data access patterns in the order.

18. The circuit of claim 17, further comprising:
a data formatting circuit, configured to:
receive a first set of signals of the plurality of signals, from the decoder circuit; and
perform formatting operations on fetched data based on the first set of signals, wherein the formatting operations correspond to the plurality of data access patterns and are performed in the order.

19. The circuit of claim 18, wherein the decoder circuit comprises:
a first register, having an input coupled to the queue and configured to receive the indications individually in the order and to output each of the indications individually in the order;
a second register, having an input coupled to an output of the first register and configured to receive each of the indications individually in the order from the first register;
a first multiplexer, coupled to the output of the first register, wherein the first multiplexer is configured to output the set of signals based on a first indication received from the first register; and
a second multiplexer, coupled to an output of the second register, wherein the second multiplexer is configured to output the first set of signals based on a second indication received from the second register.

20. The circuit of claim 19, wherein the first multiplexer is coupled to the address generator circuit and is configured to transmit the set of signals to the address generator circuit, further wherein the second multiplexer is coupled to the data formatting circuit and is configured to transmit the first set of signals to the data formatting circuit.
